(19) United States
(12) Patent Application Publication
(10) Pub. No.: US 2026/0023261 A1
(43) Pub. Date: Jan. 22, 2026

(54) DISPLAY DEVICE

(71) Applicant: Japan Display Inc., Tokyo (JP)

(72) Inventors: Kenichi TAKEMASA, Tokyo (JP); Kazuyuki YAMADA, Tokyo (JP); Keisuke ASADA, Tokyo (JP); Daiki ISONO, Tokyo (JP)

(21) Appl. No.: 19/257,780

(22) Filed: Jul. 2, 2025

(30) Foreign Application Priority Data
Jul. 18, 2024 (JP) 2024-114959

(51) Int. Cl. G02B 27/01

(52) U.S. Cl. CPC G02B 27/0103; G02B 2027/012

(57) ABSTRACT

The display device includes the light source including a plurality of light-emitting units, the aerial imaging plate, and the light-shielding members. The light-shielding members are arranged between the aerial imaging plate and the light source. The light-shielding members can shield portions of the light source light incident from the light source. Specifically, the can light-shielding members selectively shield light (components) that travels parallel to a first direction or a second direction in plan view, out of the light source light incident from the light source.

### CROSS REFERENCES TO RELATED APPLICATIONS

The present application claims priority to Japanese Patent Application No. 2024-114959 filed on Jul. 18, 2024, the disclosure of which is incorporated herein by reference.

### BACKGROUND

The present disclosure relates to a display device capable of forming an image in midair.

There is a technique to form an image in midair by reflecting light emitted from a display, which serves as a light source, using a plurality of mirror plates. For example, refer to International Publication No. WO2016/132568 (Patent Document 1).

### SUMMARY

Upon examining a type of display device in which light is reflected by a plurality of mirror plates, the inventors of the present application have found that there remains room for improvement in such a device. For example, in a type of display device that forms an image in midair by reflecting light incident from a light source twice using mirror plates arranged at different angles, a secondary image (ghost) can be observed in addition to the primary image formed at the designated position. From the standpoint of improving the display quality of a display device, a state is preferable where only the primary image is observable and that any secondary images are not observed.

According to one embodiment of the disclosure, a display device includes a light source includes a plurality of light-emitting units, an aerial imaging plate including a plurality of mirror plates and capable of forming an image in midair by reflecting light incident from the light source, and light-shielding members arranged between the aerial imaging plate and the light source, the light-shielding members shielding a portion of the light incident from the light source. The plurality of mirror plates includes a first mirror plate having a first reflective surface facing a first direction and a second reflective surface facing in a direction opposite to the first direction, and a second mirror plate having a third reflective surface facing a second direction that is orthogonal to the first direction and a fourth reflective surface facing in a direction opposite to the third reflective surface. The second mirror plate is arranged so as to overlap a portion of the first mirror plate in a third direction orthogonal to each of the first direction and the second direction, and is arranged closer to the light source than the first mirror plate is. The light-shielding members are capable of selectively shielding light, out of the light incident from the light source, that travels parallel to the first direction or the second direction.

### BRIEF DESCRIPTION OF THE DRAWINGS

FIG. 1 is an explanatory diagram illustrating a state in which light from a light source is formed into an image in midair.

FIG. 2 is a plan view of the light source illustrated in FIG. 1, as viewed from a light-irradiation surface side.

FIG. 3 is a plan view of an aerial imaging plate illustrated in FIG. 1, as viewed from above.

FIG. 4 is a plan view illustrating a configuration example of a display device according to the present embodiment.

FIG. 5 is a side view of the display device illustrated in FIG. 4.

FIG. 6 is a plan view of the light source and a plurality of light-shielding members illustrated in FIG. 5, as viewed with the light-shielding surfaces facing the front.

FIG. 7 is an enlarged plan view illustrating the positional relationship between a light-emitting unit illustrated in FIG. 4 and two light-shielding members located in its vicinity.

FIG. 8 is a plan view illustrating a configuration example of a display device as a modification of that illustrated in FIG. 4.

FIG. 9 is a side view of the display device illustrated in FIG. 8.

FIG. 10 is a plan view of the light source and a plurality of light-shielding members illustrated in FIG. 9, as viewed with the light-shielding surfaces facing the front.

### DETAILED DESCRIPTION

Hereinafter, an embodiment of the present disclosure will be described with reference to the drawings. It should be noted that the disclosure is merely an example, and various modifications that may be readily conceived by those skilled in the art without departing from the spirit of the disclosure are naturally included within the scope of the present disclosure. In addition, the drawings may schematically represent the widths, thicknesses, shapes, and other aspects of the components, as compared to the actual embodiment, for the sake of clarity of explanation. However, these are merely illustrative examples and are not intended to limit the interpretation of the present disclosure. In addition, in the present specification and the accompanying drawings, elements that are the same as or similar to those described with reference to previously presented drawings are denoted by the same or corresponding reference numerals, and detailed explanations thereof may be omitted as appropriate.

### <Display Device Capable of Forming Image in Midair>

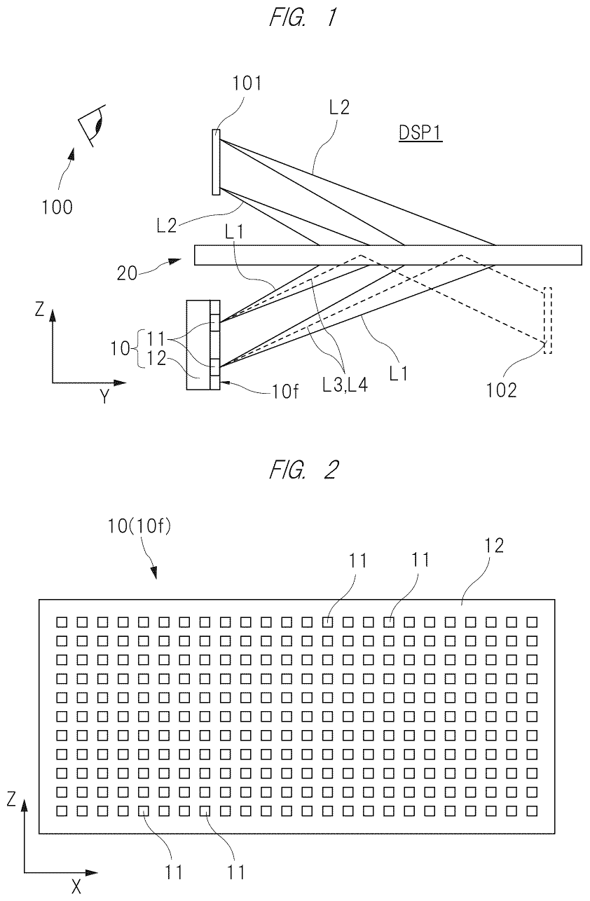

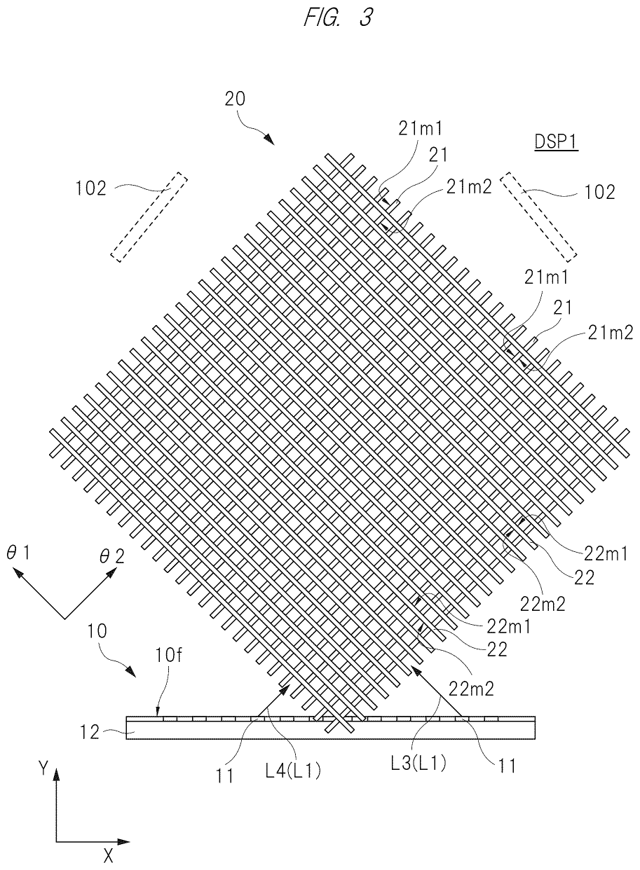

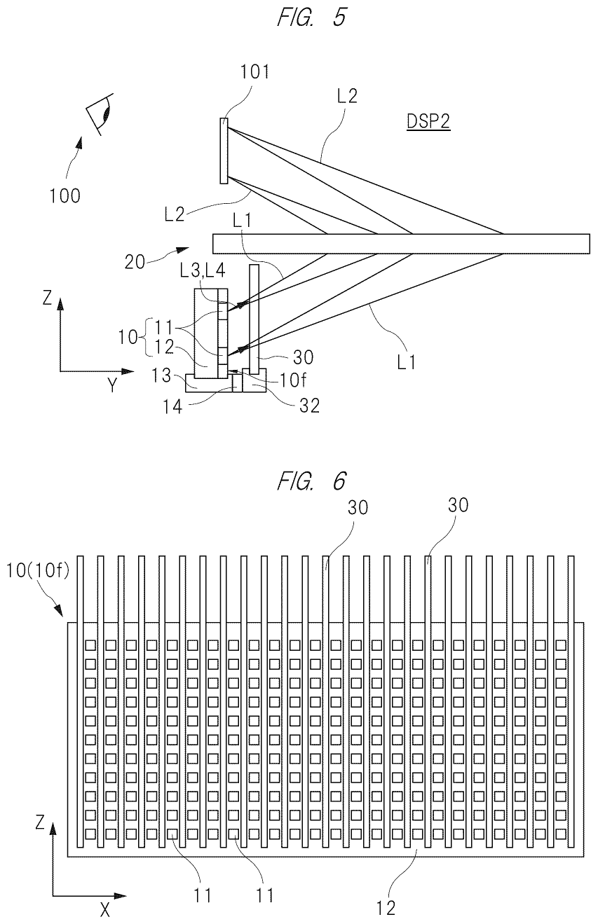

First, a method of displaying an image or a video using a display device capable of forming an image in midair using light from a light source will be described. FIG. 1 is an explanatory diagram illustrating a state in which light from a light source is formed into an image in midair. FIG. 2 is a plan view of the light source illustrated in FIG. 1, as viewed from a light-irradiation surface side. FIG. 3 is a plan view of an aerial imaging plate illustrated in FIG. 1, as viewed from above. As illustrated in FIG. 5, which will be described later, a display device DSP2 according to the present embodiment includes light-shielding members 30 arranged between an aerial imaging plate 20 and a light source 10. FIGS. 1 to 3 illustrate a display device DSP1 which is an examination example of the display device DSP2 of the present embodiment.

FIG. 3 illustrates an X direction, a Y direction, a θ1 direction, and a θ2 direction. The X direction and the Y direction intersect with each other. In the example described below, the X direction is orthogonal to the Y direction. Also, the θ1 direction and the θ2 direction intersect with each other. In the example described below, the θ1 direction is orthogonal to the θ2 direction. Also, in the example described below, the θ1 direction and the θ2 direction intersect with the X direction and the Y direction, respectively. Moreover, the X direction, the Y direction, the θ1 direction, and the θ2 direction are all included in the same plane (X-Y plane). In the following description, unless otherwise specified to indicate a different meaning, the term “planar view” refers to a view of a plane parallel to the X-Y plane. As will be described later, the direction normal to the X-Y plane is referred to as a “Z direction” or the thickness direction. The X direction, the Y direction, and the Z direction are directions that intersect with one another, and more specifically, are orthogonal to one another.

The display device DSP1 illustrated in FIG. 1 includes the light source 10 and the aerial imaging plate 20. The light source 10 includes a plurality of light-emitting units 11. Although two light-emitting units are illustrated in FIG. 1, the number of light-emitting units 11 is not limited to two. For example, as illustrated in FIG. 2, the light source 10 has the plurality of light-emitting units 11 arranged in an array (matrix) pattern. In the example illustrated in FIG. 2, the light source 10 has a substrate 12 and the plurality of light-emitting units 11 arranged on the substrate 12. Each of the plurality of light-emitting units 11 is, for example, an LED element. For example, when a display device such as a liquid crystal display device is used as the light source 10, each of the plurality of light-emitting units 11 corresponds to one of a plurality of pixels partitioned by a light-shielding film (not illustrated).

As illustrated in FIG. 3, the aerial imaging plate 20 includes a plurality of mirror plates (mirror plates 21 and mirror plates 22). The aerial imaging plate 20 is an optical member capable of forming an image 101 in midair as illustrated in FIG. 1 by reflecting light incident from the light source 10 twice by the mirror plates 21 and the mirror plates 22.

A mirror plate 21 has a reflective surface 21m1 facing in the θ1 direction. In the example illustrated in FIG. 3, the mirror plate 21 has reflective surfaces on both sides. That is, the mirror plate 21 has the reflective surface 21m1 facing in the θ1 direction and a reflective surface 21m2 facing in the opposite direction to the θ1 direction.

The mirror plates 22 have a reflective surface 22m1 facing in the θ2 direction. In the example illustrated in FIG. 3, the mirror plates 22 have reflective surfaces on both sides. That is, the mirror plates 22 have the reflective surface 22m1 facing in the θ2 direction and a reflective surface 22m2 facing in the opposite direction to the θ2 direction.

The θ1 direction and the θ2 direction are orthogonal to each other. In the example illustrated in FIG. 3, the aerial imaging plate 20 includes the plurality of mirror plates 21 arranged in the θ1 direction and the plurality of mirror plates 22 arranged in the θ2 direction. In the example illustrated in FIG. 3, the plurality of mirror plates 22 is arranged, each being placed on the plurality of mirror plates 21. In other words, in the thickness direction of the aerial imaging plate 20 (the Z direction illustrated in FIG. 1), the plurality of mirror plates 21 is arranged closer to the light source 10 than the plurality of mirror plates 22 is.

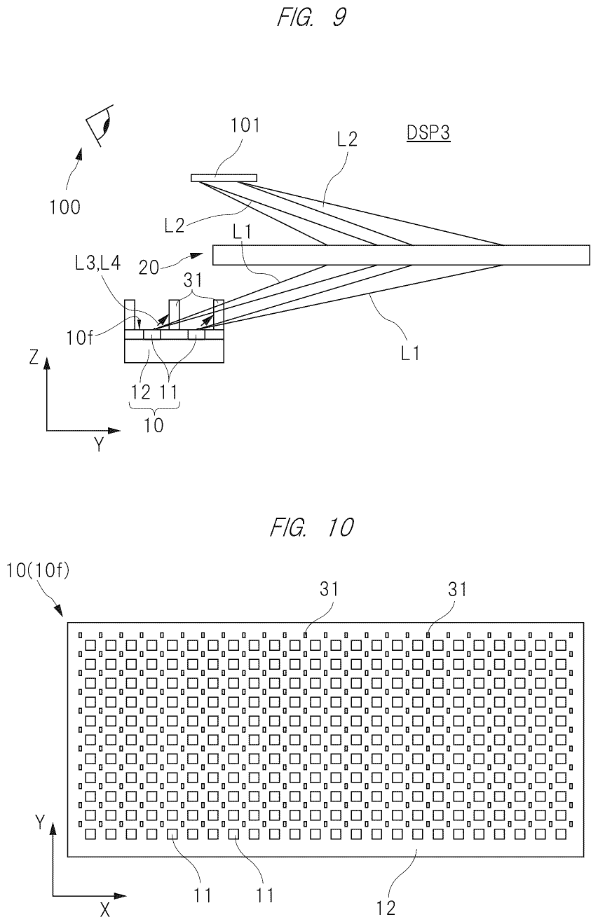

As schematically illustrated in FIG. 1, light source light L1 emitted from the light-emitting unit 11 of the light source 10 is incident on the aerial imaging plate 20. Most of the light source light L1 is reflected once by each of the mirror plates 21 and the mirror plates 22 illustrated in FIG. 3 in the aerial imaging plate 20, and is emitted above the aerial imaging plate 20 as reflected light L2 illustrated in FIG. 1. The reflected light L2 then forms the image 101 in midair. An observer 100 can observe the image 101 formed in midair. The image 101, which is an aerial video, is a video displayed by the light source 10 and is observed as floating in a position symmetrical to the light source 10 with the aerial imaging plate 20 serving as the axis of symmetry. For example, in the example illustrated in FIG. 1, the light source 10 is arranged along the Z direction perpendicular to the X-Y plane, and therefore the image 101 is also observed as a planar image along the Z direction perpendicular to the X-Y plane. Similarly, an image 102, which will be described later, is observed as a planar image along the Z direction perpendicular to the X-Y plane. On the other hand, as illustrated in FIG. 9, which will be described later, when the light source 10 is arranged along the X-Y plane, the image 101 is observed as a planar image along the X-Y plane.

### <Ghost Image>

According to the examination by the present inventors, in the case of the display device DSP1 illustrated in FIGS. 1 to 3, it has been found that the observer 100 observes the image 102 in addition to the image 101, as schematically illustrated by the dotted line in FIG. 1. The image 102 is formed at a position different from that of the image 101. The image 102 is an image that is not intended to be observed by the observer 100. Hereinafter, an image that is not intended to be observed by the observer 100, such as an image 102, in other words, an image that is preferably not observed by the observer 100 from the viewpoint of display quality, will be referred to as a ghost image.

The image 102, which is a ghost image, is formed by the light source light L1 being reflected only once at the aerial imaging plate 20. As described above, the image 101 is an image obtained by the light source light L1 being reflected twice by the aerial imaging plate 20.

However, since the light source light L1 travels radially from the light-emitting units 11, portions of the light source light L1 are reflected by only one of the mirror plate 21 and the mirror plate 22 illustrated in FIG. 3. Specifically, as illustrated in FIG. 3, a component L3 of the light source light L1 that travels parallel to the θ1 direction in plan view is reflected by the mirror plate 21 but is not reflected by the mirror plate 22. Similarly, a component L4 that travels parallel to the θ2 direction is reflected by the mirror plate 22 but is not reflected by the mirror plate 21.

The component L3 and the component L4 are each formed at positions different from the image 101 illustrated in FIG. 1, and are observed by the observer 100 as the image 102, which is a ghost image. In the case of the layout illustrated in FIG. 3, the image 102 is formed at two locations on the opposite side (the back side) of the light source 10 via the aerial imaging plate 20 in plan view. It should be noted that the light source light L1 may contain a component that is not incident on the aerial imaging plate 20, in other words, that is not reflected by the aerial imaging plate 20 even once. However, the component that is not incident on the aerial imaging plate 20 does not form an image in midair. Therefore, regarding the ghost image, the component that is not incident on the aerial imaging plate 20 can be disregarded.

<Display Device Capable of Suppressing Formation of Ghost Images>

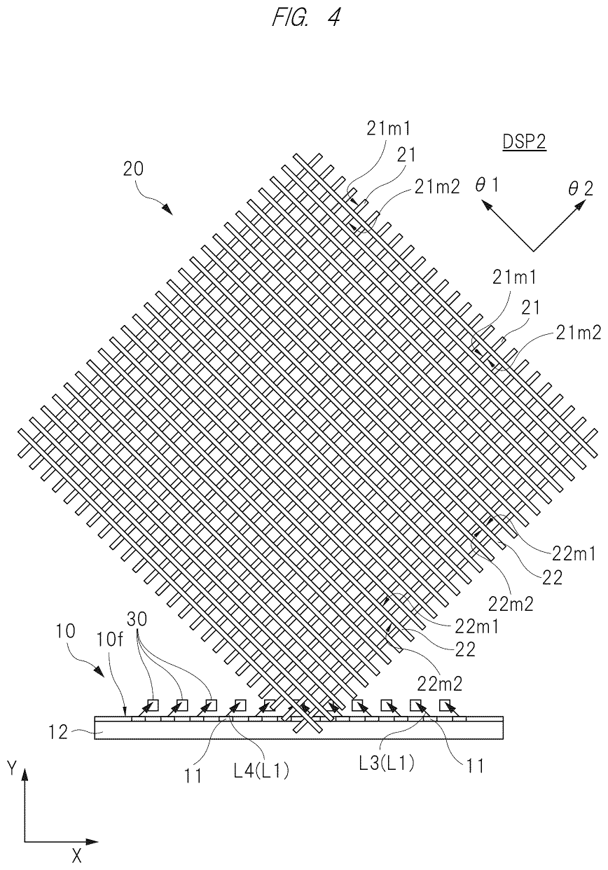

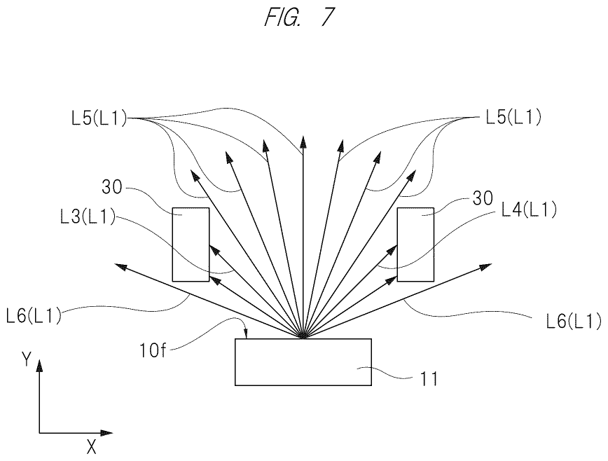

Next, a display device capable of suppressing formation of the image 102 illustrated in FIGS. 1 and 3 will be described. FIG. 4 is a plan view illustrating a configuration example of a display device according to the present embodiment. FIG. 4 corresponds to the plane illustrated in FIG. 3. FIG. 5 is a side view of the display device illustrated in FIG. 4. Similarly to FIG. 1, in FIG. 5, the traveling directions of the light source light L1 incident from the light source 10 and the reflected light L2 reflected by the aerial imaging plate 20 are schematically illustrated. FIG. 6 is a plan view of the light source and a plurality of light-shielding members illustrated in FIG. 5, as viewed with the light-shielding surfaces facing the front. FIG. 7 is an enlarged plan view illustrating the positional relationship between the light-emitting unit illustrated in FIG. 4 and two light-shielding members located in its vicinity.

The display device DSP2 of the present embodiment is similar to the display device DSP1 described referring to FIGS. 1 to 3, except that light-shielding members 30 are provided between the aerial imaging plate 20 and the light source 10.

Specifically, the display device DSP2 includes the light source 10 including the plurality of light-emitting units 11, the aerial imaging plate 20, and the light-shielding members 30. The structure of the light source 10 is as described with reference to FIG. 2. Also, the structure of the aerial imaging plate 20 is as described with reference to FIG. 3.

As described above, the light-shielding members 30 are arranged between the aerial imaging plate 20 and the light source 10. The light-shielding members 30 can shield portions of the light source light L1 incident from the light source 10. Specifically, the light-shielding members 30 can selectively shield light (component L3 and component L4) that travels parallel to the θ1 direction or the θ2 direction in plan view, out of the light source light L1 incident from the light source 10.

In the present embodiment, the light (component L3 and component L4 of the light source light L1) that causes the ghost image 102 described with reference to FIG. 1 is shielded by the light-shielding members 30. Accordingly, in the case of the display device DSP2, the formation of the image 102 illustrated in FIGS. 1 and 3 can be suppressed.

Also, as described above, the light source light L1 may contain a component that is not incident on the aerial imaging plate 20. However, since the component that is not incident on the aerial imaging plate 20 can be disregarded, it does not matter whether the component is shielded by the light-shielding members 30 or not.

Also, as illustrated in FIG. 5, the light source 10 has a light-irradiation surface 10f on which the plurality of light-emitting units 11 is arranged in an array pattern. The light-irradiation surface refers to a surface on which the plurality of light-emitting units 11, more specifically, the starting points from which the light source light L1 is emitted, is arranged. For example, when the light source 10 is a liquid crystal display device or a micro LED display device, the light-irradiation surface 10f is the front surface of the substrate on the light-irradiation surface side of the display device. The light source 10 is arranged such that the light-irradiation surface 10f faces any direction within a plane including the θ1 direction and the θ2 direction illustrated in FIG. 4 (in other words, the X-Y plane including the X direction and the Y direction). In the example illustrated in FIG. 5, the light-irradiation surface 10f faces the Y direction. In other words, the light source 10 is arranged such that the angle between the light-irradiation surface 10f and the plane including the θ1 direction (see FIG. 4) and the θ2 direction (see FIG. 4)—namely, the X-Y plane illustrated in FIG. 4—is 90 degrees.

Furthermore, in the plan view illustrated in FIG. 4, the θ1 direction and the θ2 direction do not coincide with the Y direction which is the normal direction of the light-irradiation surface 10f. In other words, the light source 10 is arranged such that the light-irradiation surface 10f faces in a direction intersecting both the θ1 direction and the θ2 direction. In the example illustrated in FIG. 4, the angle between the Y direction and the θ1 direction, and the angle between the Y direction and the θ2 direction are both 45 degrees.

As described above, the light-shielding members 30 can selectively shield light (component L3 and component L4) that travels parallel to the θ1 direction or the θ2 direction in plan view, out of the light source light L1 incident from the light source 10. Accordingly, of the light source light L1, the light that does not affect the formation of the image 102 (see FIG. 3), in other words, the light that travels in a direction in which it is reflected twice on the aerial imaging plate 20, is less likely to be shielded by the light-shielding members 30 and is incident toward the aerial imaging plate 20. Therefore, similarly to the display device DSP1 illustrated in FIG. 1, the display device DSP2 can form the image 101 in midair.

It should be noted that the light-shielding members 30 do not shield only the component L3 and the component L4 of the light source light L1, but may shield components other than the component L3 and the component L4. From the viewpoint of reliably preventing the formation of ghost images, it is preferable to be able to reliably shield the light of the component L3 and the component L4, and therefore it is preferable that each of the plurality of light-shielding members 30 is large in size.

However, if the size of the light-shielding members 30 is increased, the amount of the component of the light source light L1 that is shielded by the light-shielding members 30 also increases. Therefore, the viewpoint of improving the brightness of the image 101 illustrated in FIG. 1, it is preferable that the size of the light-shielding members 30 be made as small as necessary.

In the case of the layout illustrated in FIG. 4, it is preferable that each of the plurality of light-shielding members 30 has the following structure or layout. That is, as illustrated in FIG. 6, each of the plurality of light-shielding members 30 extends along the light-irradiation surface 10f. In addition, in the arrangement of the plurality of light-emitting units 11 illustrated in FIG. 6, when a direction along the X direction is the row direction and a direction along the Z direction is the column direction, each of the plurality of light-shielding members 30 is arranged between adjacent light-emitting units 11 in the row direction. In this case, it is possible to shield the light of the light source light L1 emitted from each of the plurality of light-emitting units 11 that correspond to the component L3 and the component L4 illustrated in FIG. 4 in the vicinity of the light source 10.

As illustrated in FIG. 6, when the light-irradiation surface 10f is viewed from the front, portions of the light-shielding members 30 protrude outward from the light-irradiation surface 10f toward the aerial imaging plate 20 (see FIG. 5). In the example illustrated in FIG. 6, the portion of each of the plurality of light-shielding members 30 protrudes outward from the light-irradiation surface 10f. The light source light L1 incident from the light-emitting units 11 may contain a component that forms an acute angle (for example, 45 degrees or less) with the light-irradiation surface 10f in the side view illustrated in FIG. 5. When the portions of the light-shielding members 30 protrude toward the aerial imaging plate 20, they can shield light having a component that forms an acute angle with the light-irradiation surface 10f. Accordingly, it is possible to reliably shield the light of the light source light L1 emitted from each of the plurality of light-emitting units 11 that correspond to the component L3 and the component L4 illustrated in FIG. 4 in positions distant from the light source 10, in addition to positions in the vicinity of the light source 10.

Incidentally, as illustrated in FIGS. 4 and 5, in the present embodiment, the light-shielding members 30 are spaced apart from the light-irradiation surface 10f. In the example illustrated in FIG. 4, each of the plurality of light-shielding members 30 is spaced apart from the light-irradiation surface 10f. In other words, a space is present between the plurality of light-shielding members 30 and the light-emitting units 11.

As illustrated in FIG. 7, when the light-shielding members 30 and the light-emitting units 11 are separated from each other, a portion of the light source light L1 can travel through the gap between the light-shielding members 30 and the light-emitting units 11. That is, in the case of the present embodiment, the light source light L1 contains a component L5 that passes between the adjacent light-shielding members 30 in addition to the component L3 and the component L4 that are shielded by any of the plurality of light-shielding members 30. Furthermore, the light source light L1 contains a component L6 that passes between the light-shielding members 30 and the light-emitting units 11, in addition to the component L3 and the component L4.

When the light-shielding members 30 are in contact with the light-irradiation surface 10f, the component L6 is shielded by the light-shielding members 30. In the case of the present embodiment, since the component L6 of the light source light L1 is not shielded by the light-shielding members 30, the brightness of the image 101 illustrated in FIG. 5 can be improved compared to the case where the component L6 is shielded.

However, as a modification of the present embodiment, there is a case where the plurality of light-shielding members 30 and the light-irradiation surface 10f are in contact with each other. Details will be described later as a modification, but in this case, the light source 10 and the light-shielding members 30 can be fixed, providing the advantage of improving the positional accuracy between the light-emitting units 11 and the light-shielding members 30.

As in the present embodiment, when each of the plurality of light-shielding members 30 is spaced apart from the light-irradiation surface 10f, it is preferable to control the positional relationship between the plurality of light-shielding members 30 and the plurality of light-emitting units 11 with high accuracy. By improving the accuracy of the positional relationship between the plurality of light-shielding members 30 and the plurality of light-emitting units 11, the size of the light-shielding members 30 can be made as small as necessary.

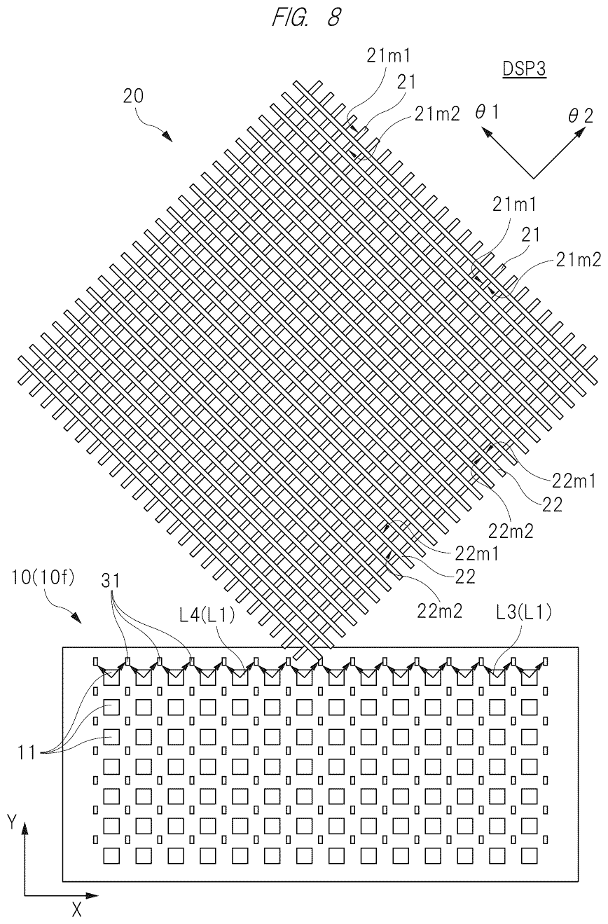

For example, when each of the plurality of light-shielding members 30 is held by a holding member 32 illustrated in FIG. 5, it is preferable that a supporting member 13 that supports the light source 10 and the holding member 32 are fixed to each other. In the example illustrated in FIG. 5, the holding member 32 and the supporting member 13 are fixed to each other via an adhesive 14. In this case, the accuracy of the positional relationship between each of the plurality of light-shielding members 30 and the plurality of light-emitting units 11 illustrated in FIG. 8 can be improved.

### <Modification of Layout of Light Source>

Next, a modification of the display device DSP2 described referring to FIGS. 4 to 7 will be described. FIG. 8 is a plan view illustrating a configuration example of a display device as a modification of that illustrated in FIG. 4. FIG. 9 is a side view of the display device illustrated in FIG. 8. Similarly to FIG. 5, in FIG. 8, the traveling directions of the light source light L1 incident from the light source 10 and the reflected light 12 reflected by the aerial imaging plate 20 are schematically illustrated. FIG. 10 is a plan view of the light source and a plurality of light-shielding members illustrated in FIG. 9, as viewed with the light-shielding surfaces facing the front.

A display device DSP3 illustrated in FIGS. 8 and 9 differs from the display device DSP2 illustrated in FIGS. 4 and 5 in the layout of the light source 10. That is, as illustrated in FIGS. 8 and 9, the light source 10 of the display device DSP3 is arranged such that the angle between the light-irradiation surface 10f and the plane including the θ1 direction and the θ2 direction (X-Y plane) is less than 90 degrees. In the example illustrated in FIGS. 8 and 9, the angle between the light-irradiation surface 10f and the X-Y plane is 0 degrees. In other words, the light-irradiation surface 10f and the X-Y plane are parallel to each other.

In the case of the display device DSP3, the component of the light source light L1 traveling directly upward the light-emitting units 11 needs to be taken into consideration. That is, when a point light source of the light-emitting unit 11 is positioned at the center of the grid formed by the plurality of mirror plates 21 and the plurality of mirror plates 22, the component of the light source light L1 that travels directly upward from the light-emitting unit 11 may travel over the aerial imaging plate 20 without being reflected by the mirror plates 21 and the mirror plates 22.

Accordingly, from the viewpoint of preventing the generation of the component of the light source light L1 traveling over the aerial imaging plate 20 without being reflected by the mirror plates 21 and the mirror plates 22, it is preferable that each of the plurality of light-emitting units 11 is arranged at a position that does not overlap with the aerial imaging plate 20 in plan view, as illustrated in FIG. 8.

In addition, in the case of the display device DSP3 according to the modification, the display device DSP3 differs from the display device DSP2 illustrated in FIGS. 4 and 5 in that the light-shielding members 31 illustrated in FIGS. 8 to 10 are provided instead of the light-shielding members 30 illustrated in FIGS. 4 to 7. The light-shielding members 31 are provided corresponding to each of the plurality of light-emitting units 11. In other words, on the light-irradiation surface 10f, the light-shielding members 31 are each arranged spaced apart from each other between the plurality of light-emitting units 11 and the aerial imaging plate 20.

Specifically, as illustrated in FIG. 8, in plan view, one light-shielding member 31 is arranged at a position advanced in the θ1 direction from the center of one light-emitting portion 11. Further, in plan view, one light-shielding member 31 is arranged at a position advanced in the θ2 direction from the center of one light-emitting portion 11.

In addition, as illustrated in FIG. 9, the light-shielding members 31 are in contact with the light-irradiation surface 10f. In the side view illustrated in FIG. 9, there are various angles formed between each of the component L3 and the component L4 of the light source light L1 and the light-irradiation surface 10f. Therefore, by bringing the light-shielding members 31 into contact with the light-irradiation surface 10f, even if the angles formed between each of the component L3 and the component L4 of the light source light L1 and the light-irradiation surface 10f are small, these components can be shielded.

In addition, as illustrated in FIG. 9, each of the plurality of light-shielding members 31 is arranged so as to protrude in an out-of-plane direction (e.g., in the normal direction) with respect to the light-irradiation surface 10f. In this case, even when each of the component L3 and the component L4 of the light source light L1 forms an angle close to 90 degrees with the light-irradiation surface 10f, these components can still be shielded.

When the light-shielding members 31 are in contact with the light-irradiation surface 10f as in the present modification, the light-shielding members 31 can be formed, for example, on the light-irradiation surface 10f. In this case, since each of the plurality of light-shielding members 31 is fixed to the light source 10, the positional accuracy of the plurality of light-shielding members 31 can be improved.

The display device DSP3 described referring to FIGS. 8 to 10 is similar to the display device DSP2 described referring to FIGS. 4 to 7, except for the above-mentioned difference. Accordingly, a redundant description will be omitted.

Although the embodiment and typical modification have been described above, the above-described technique can be applied to various modifications other than the modification given as an example. For example, the above-described modifications may be combined.

It is to be understood that various changes and modifications may be conceived by those skilled in the art within the scope of the spirit of the present disclosure, and such changes and modifications are also considered to fall within the scope of the present disclosure. For example, modifications made by those skilled in the art to the above-described embodiment-such as the addition, deletion, or design changes of components, or the addition, omission, or alteration of process steps—are also included within the scope of the present disclosure, as long as the essential features of the disclosure are maintained.

What is claimed is:

1. A display device comprising:
a light source includes a plurality of light-emitting units;
an aerial imaging plate including a plurality of mirror plates and capable of forming an image in midair by reflecting light incident from the light source; and
light-shielding members arranged between the aerial imaging plate and the light source, the light-shielding members shielding a portion of the light incident from the light source,
wherein the plurality of mirror plates includes
a first mirror plate having a first reflective surface facing a first direction and a second reflective surface facing in a direction opposite to the first direction, and
a second mirror plate having a third reflective surface facing a second direction that is orthogonal to the first direction and a fourth reflective surface facing in a direction opposite to the third reflective surface,
wherein the second mirror plate is arranged so as to overlap a portion of the first mirror plate in a third direction orthogonal to each of the first direction and the second direction, and is arranged closer to the light source than the first mirror plate is, and
wherein the light-shielding members are capable of selectively shielding light, out of the light incident from the light source, that travels parallel to the first direction or the second direction in plan view.

2. The display device according to claim 1,
wherein the light source has a light-irradiation surface on which the plurality of light-emitting units is arranged in an array pattern, and
wherein the light source is arranged such that the light-irradiation surface faces in any direction within a plane including the first direction and the second direction.

3. The display device according to claim 2,
wherein the light-shielding members extend in the third direction along the light-irradiation surface.

4. The display device according to claim 3,
wherein the plurality of light-emitting units is arranged in a column direction along the third direction and in a row direction orthogonal to the column direction, and
wherein the light-shielding members are arranged between adjacent light-emitting units in the row direction.

5. The display device according to claim 4,
wherein, when the light-irradiation surface is viewed from front, portions of the light-shielding members protrude outward from the light-irradiation surface toward the aerial imaging plate.

6. The display device according to claim 2,
wherein the light source is arranged such that the light-irradiation surface faces in a direction intersecting both the first direction and the second direction.

7. The display device according to claim 1,
wherein the light source has a light-irradiation surface on which the plurality of light-emitting units is arranged in an array pattern, and
wherein the light-shielding members are spaced apart from the light-irradiation surface.

8. The display device according to claim 1,
wherein the light source has a light-irradiation surface on which the plurality of light-emitting units is arranged in an array pattern, and
wherein the light source is arranged such that the angle between the light-irradiation surface and a plane including the first direction and the second direction is greater than or equal to 0 degrees and less than 90 degrees.

9. The display device according to claim 8,
wherein, on the light-irradiation surface, the light-shielding members, which are spaced apart from each other and positioned between the plurality of light-emitting units and the aerial imaging plate, are respectively arranged.

10. The display device according to claim 1,
wherein the light source has a light-irradiation surface on which the plurality of light-emitting units is arranged in an array pattern, and
wherein the light-shielding members are in contact with the light-irradiation surface.
